(19) United States
(12) Patent Application Publication
(10) Pub. No.: US 2002/0021955 A1
(43) Pub. Date: Feb. 21, 2002

(54) Track guided vehicle system

(75) Inventor: Masatomi Kawaguchi, Kagamigahara-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 09/875,940

(22) Filed: Jun. 8, 2001

(30) Foreign Application Priority Data
Aug. 11, 2000 (JP) 2000-243741

(51) Int. Cl. B65G 1/00

(52) U.S. Cl. 414/278

(57) ABSTRACT

With sidings 6,7 installed between main lines 4,5 of the track guided vehicle system and the upper part of the rack 24 of an automatic warehouse 20, articles are transferred directly between a stacker crane 22 and the primary ground linear conveyer vehicle 14. The main line is never blocked by the linear conveyance vehicle in the transferring in the section to the automatic warehouse, and the siding can be used as a turnout to overtake.

### FIELD OF THE INVENTION

This present invention relates to a track guided vehicle system.

### BACKGROUND OF THE INVENTION

A combination of a track guided vehicle system and an automatic warehouse is widely used. Forms of a connection between the track guided vehicle system and the automatic warehouse varies, however, in the case that the track guided vehicle is not equipped with a transfer equipment, the transfer equipment is installed on the side of the automatic warehouse adjacent to a stop position of the track guided vehicle to transfer. In the case that the track guided vehicle is equipped with the transfer equipment, the track guided vehicle is made to stop at the position adjacent to a station of the automatic warehouse to transfer articles in a section to station.

When articles are transferred between the track guided vehicle and the automatic warehouse, the track guided vehicle is stopped. Therefore, a traveling rail of the track guided vehicle is blocked during the period, and the following track guided vehicle has no choice but to stop. Consequently, it reduces transferring efficiency of the track guided vehicle system.

It is the fundamental object of this invention to provide a system which the following track guided vehicle can travel without a hitch regardless of the presence of the track guided vehicle in the transferring in a section to the automatic warehouse, to minimize additional space for providing with a siding, and to enable articles to be transferred easily between the automatic warehouse and the track guided vehicle.

It is a further object of this invention to provide the track guided vehicle system which articles can be loaded directly between a conveyer in the automatic warehouse and the track guided vehicle which does not have the transfer equipment, and a drop in ability of conveyance caused by the track guided vehicle waiting for a free conveyer is small.

### SUMMARY OF THE INVENTION

The present invention is a track guided vehicle system in which a track guided vehicle is made to run along a traveling rail, wherein a main line and a siding diverging from the main line to a transfer position for articles in a section to an automatic warehouse are provided.

It is preferable to place the siding in such a manner as to be lapped over a rack in the automatic warehouse in top view in part at least.

Moreover, the automatic warehouse is equipped with a conveyer which is provided with a transfer equipment and travels in the automatic warehouse, and the track guided vehicle is a conveyer vehicle which does not equipped with a transfer equipment to convey articles loaded on its carrier. The articles are transferred directly between a linear conveyer vehicle, stopped on a siding lapped over the rack as the conveyer vehicle, and the conveyer.

### BRIEF DESCRIPTION OF THE DRAWING

FIG. 1 is a top view showing a layout of track guide vehicle system provided with a siding in an embodiment.

FIG. 2 is a top view showing a divergence between the main line and the siding used in the embodiment.

FIG. 3 is a front view showing a layout of racks for an automatic warehouse, the siding, and the main line in the embodiment.

### DETAILED DESCRIPTION OF THE PREFERRED EMBODIMENTS

In accordance with the present invention, a track guided vehicle transfers articles in a section to an automatic warehouse on a siding, so that a following track guided vehicle can travel on the main line and it improves transferring efficiency of a track guided vehicle system. The siding can be used as a turnout, for example it is possible to have an unloaded track guided vehicle stepped aside to overtake.

Furthermore, space for providing the siding can be reduced, since the siding is placed on the upper part or a part of the rack. For example, if the track guided vehicle is provided with a transfer equipment fitted with an elevatable hand, articles can be unloaded and loaded articles from the rack or can be exchanged directly between the track guide vehicle and a conveyer of the automatic warehouse, and it becomes easier to transfer articles between the track guide vehicle and a conveyer of the automatic warehouse.

Moreover, articles are directly transferred between a linear conveyer vehicle stopped on the siding where the rack is lapped over and the conveyer of the automatic warehouse by using the linear conveyer vehicle unequipped with the transfer equipment and loaded with articles without the transfer equipment. Conventionally, when this kind of the linear conveyer vehicle was connected to the automatic warehouse, an auxiliary transfer equipment was necessary on the side of the automatic warehouse, however, the transfer equipment like this becomes unnecessary according to the present invention. Preferably, the linear conveyer vehicle is used as the linear conveyer vehicle of a primary of linear motor on the track side, which costs less compared with the track guided vehicle equipped with a linear motor on the vehicle side, so it is possible to put a large number of vehicles into the system and minimize a drop in transferring efficiency even though it is kept waiting on the siding. On the grounds of these points, it is possible to compose the particularly efficient track guided vehicle system.

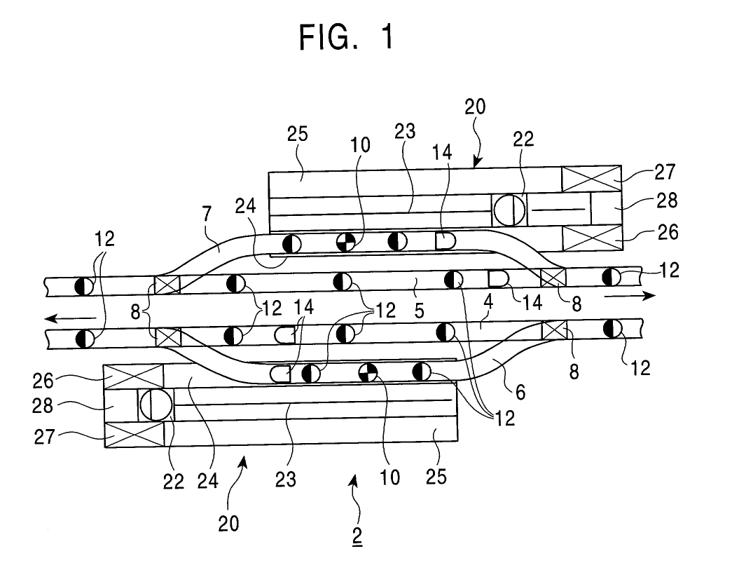

FIGS. 1 to 3 show an embodiment. In the embodiment, a track guided vehicle system 2 comprises main lines 4,5 and sidings 6,7 which diverge therefrom, and the main lines 4,5 are composed in a loop for example, and the sidings 6,7 are placed along the main lines 4,5 in a proper position for example in a plurality of positions. The both ends of the sidings 6,7 are connected to the main lines 4,5 with a converging/diverging devices 8,8. 10 is a transfer position where the track guided vehicle (a linear conveyer vehicle) stops when articles are transferred in a section to an automatic warehouse and are placed in the sidings 6,7, and 12 is a waiting position and arranged in the main lines 4,5 and the sidings 6,7. 14 is the linear conveyer vehicle as an example of the track guided vehicle, which is regarded as a primary of linear motor conveyer vehicle on the track side here, not provided with a transfer equipment etc., loads its carrier with articles, and travels by a linear motor installed on the track side. The transfer position 10 and the waiting position 12 are provided with the primary side of the linear motor to stop and start the linear conveyer vehicle 14.

As for the track guided vehicle, it is acceptable to use not only the primary of linear conveyer vehicle 14 on the track side but also the primary of linear conveyer vehicle on the vehicle side or a normal induction motor or a servomotor driven track guided vehicle. In the embodiment, the main lines 4,5 and the sidings 6,7 are installed in the vicinity of a ceiling in a clean room, but any height of these placement may be chosen, for example it can be installed at floor level. Installation positions of the main lines 4,5 are not only limited to the clean room but general factories or warehouses. The linear conveyer vehicle 14 travels round the main lines 4,5, and the traveling directions of the linear conveyer vehicle 14 in the main lines 4,5 are respectively contrary directions.

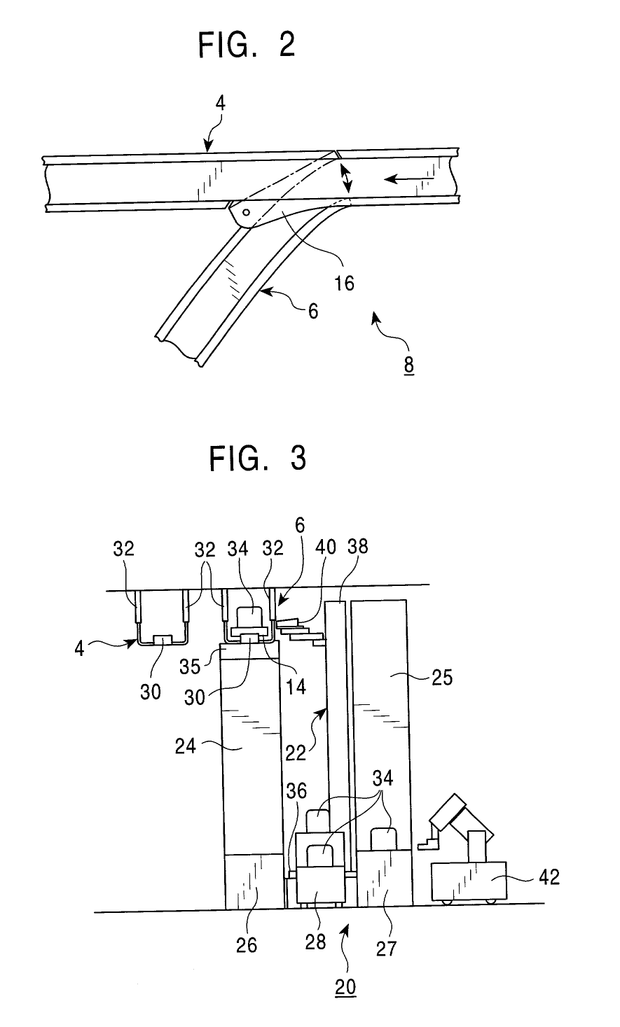

In the converging/diverging device 8 shown in FIG. 2, for example, a slide rail 16 is installed at a diverging point such as the main line 4 and the siding 6, and the divergence is controlled by making the slide rail 16 between a solid line position and a dotted line position in FIG. 2 move. Any kind of the converging/diverging device 8 is acceptable.

In FIG. 1, 20 is the automatic warehouse which is installed in such a way as to touch the sidings 6,7, and 22 is a stacker crane as a conveyer in the automatic warehouse, and 23 is its traveling rail. 24,25 are one pair of racks of the automatic warehouse, the rack 24 among them is installed at the lower part of the sidings 6,7 in a vertical direction and partly lapped over, so that the sidings 6,7 get through the upper part of the rack 24. Therefore, additional space for placing the sidings 6,7 is insignificant. 26,27 are stations provided with a conveyer and used for taking articles in and out of storage normally. 28 is an auxiliary station which is installed at the entrance of the automatic warehouse 20, facing the travel rail 23, by making use of double tables on casters, both an upper table and a lower table, so it is movable during maintenance for the automatic warehouse 20. It is not necessary to install the auxiliary station 28.

In FIG. 3, the siding 6 and the automatic warehouse 20 are taken as an example for positional relation between the siding and the automatic warehouse, and there is a rack 24 of the automatic warehouse 20 on the lower side of the siding 6 placed in parallel with the main line 4. 30 is a rail body, and 32 is a hanger which supports the rail body 30 from a ceiling and the like. 34 is an article. In the upper section of the rack 24, a filter fan unit 35 is installed to dispose of dust arising from travelling linear conveyer vehicle 14.

For example, a stacker crane 22 is provided with a turntable 36, and a mast 38 is placed on the turntable 36 to make the transfer equipment 40 move up and down along the mast 38. The mast 38 is in a hollow-cylinder-shape, and a driving section (not shown in the drawings) to move the transfer equipment 40 is placed in the cylinder. The mast 38 is provided with a slit in a vertical direction for a joint section of the transfer equipment 40 and the above driving section to move up and down, and the slit is covered with a movable shutter (not shown in the drawings), and air is sucked from the bottom of the mast 38 via the turntable 36 and exhausted toward the under floor to prevent the arising dust. Since the stacker crane 22 is provided with the turntable 36, it is possible to transfer the article 34 in the 360 degrees all-round direction.

The stations 26,27 are provided with conveyers respectively and have the capacity to stock a plurality of articles 34 in each station, for example, the station 26 is a store station, and the station 27 is a retrieving station. 42 is a transfer robot which travels on the floor surface of the clean room, has a robot for transfer on the vehicle, and conveys the articles 34 between the stations 26˜28 and a semiconductor processing equipment etc. The kind of conveyance articles is optional.

The auxiliary station 28 is a special station for conveyance of rush articles etc. and does not produce any dust because it is not provided with a system such as a conveyer. For example, the upper table is allocated only for storing articles, and the lower table is allocated only for storing articles. As the stacker crane 22 is provided with the turntable 36, it is possible to transfer directly not only to the stations 26,27 but the auxiliary station 28 by using the stacker crane 22 . The transfer robot 42 is loaded with the polyarticular robot, so that it is possible to unload and load the upper or lower stand of the auxiliary station 28 respectively with articles.

The operation of the track guided vehicle system in the embodiment is shown. The linear conveyer vehicle 14 transferring articles in the section to the automatic warehouse 20 stops at the transfer position 10 of the sidings 6,7, waits for the stacker crane 22 to arrive, and transfers articles directly by the transfer equipment 40 of the stacker crane 22. During this period, the following linear conveyer vehicle overtakes the linear conveyer vehicle in course of transfer and travels on the main lines 4,5.

In the case of the embodiment, as transfer is done on the sidings 6,7, it is possible to gain the conveyance ability, which is equivalent to that of four tracks, using the main lines 4,5 of a double track. It may have the unloaded linear conveyance vehicle etc. on standby at the waiting position 12 placed on the sidings 6,7. Therefore, it is possible to overtake among these linear conveyer vehicles and giving the rush articles priority to convey for example. As the linear conveyer vehicle which is not provided with the transfer equipment on the primary ground comes at a low price, it is possible to introduce large numbers of vehicles. Placing a plurality of the waiting positions 12 on the sidings 6,7, permits the linear conveyer vehicle ,which finished transferring, to be moved to transfer articles on another linear conveyer vehicle. Moreover, placing a plurality of the waiting positions 12 permits a plurality of the linear conveyer vehicle to step aside at a time and the linear conveyer vehicle conveying rush articles to overtake more effectively.

The linear conveyer vehicle 14 stops at the top part of the rack 24, and arising dust from the installed siding 6 may be disposed of with the filter fan unit 35. Since articles may be transferred directly to the linear conveyer vehicle 14 with a stacker crane 22, a fixed transfer equipment between the linear conveyer vehicle, which was necessary conventionally, and the automatic warehouse becomes unnecessary. The sidings 6,7 are installed on the rack 24, so additional space is minimized.

In the embodiment, since the main lines 4,5 are installed in the vicinity of the ceiling, the sidings 6,7 are placed on the rack 24. When installation height of the main lines 4,5 is changed, the installation height of the siding is changed accordingly, and articles may be passed through inside of the rack 24 or around the bottom part of the rack 24.

Furthermore, in the embodiment, the slide rail 16 makes a conveyance vehicle diverge, however, it is also acceptable to install a diverging device on the conveyance vehicle side and make the conveyance vehicle itself choose whether or not to go into the siding.

Additionally, in the embodiment, the conveyance vehicle is used as the primary of linear motor vehicle on the track side and the transfer equipment is not installed, however, the transfer equipment which is capable of moving up and down using a suspension member such as a wire may be installed on the conveyance vehicle with a hoisting table equipped with a hand for gripping articles.

1. A track guided vehicle system which makes a track guided vehicle travel along a traveling rail linking to an automatic warehouse, comprising:
providing the traveling rail with a main line and a siding diverging from the main line and reaching to a transfer position for an article in the automatic warehouse; and
placing the siding including the transfer position in such a way as to partly lap over a rack of the automatic warehouse in top view.

2. A track guided vehicle system according to claim 1, wherein the automatic warehouse possesses a conveyer equipped with a transfer equipment which travels in the automatic warehouse to transfer the article from rack to rack, and the transfer equipment transfers the article directly between the track guided vehicle stopped on the siding and a conveyer.

3. A track guided vehicle system according to claim 2, wherein the track guided vehicle is a linear conveyer vehicle which is loaded with the article on a table to convey.
